(19) United States
(12) Patent Application Publication
(10) Pub. No.: US 2018/0361304 A1
(43) Pub. Date: Dec. 20, 2018

(54) SCRUBBER SYSTEM WITH DIFFRACTION PLATE ADAPTED FOR SWIRL BUBBLE GENERATION FOR EFFECTIVE REMOVAL OF POLLUTANTS

(71) Applicants: Seung Uk Choi, Seongnam-si, (KR); Hyun Jun Choi, Seongnam-si (KR); Kumho Environment Co., Ltd., Seongnam-si (KR)

(72) Inventors: Seung Uk CHOI, Seongnam-si (KR); Hyun Jun CHOI, Seongnam-si (KR)

(73) Assignees: Kumho Environment Co., Ltd, Seongnam-si (KR); Seung Uk Choi, Seongnam-si (KR); Hyun Jun Choi, Seongnam-si (KR)

(21) Appl. No.: 15/669,539

(22) Filed: Aug. 4, 2017

(30) Foreign Application Priority Data
Jun. 19, 2017 (KR) 10-2017-0077410

(51) Int. Cl. B01D 47/14

(52) U.S. Cl. CPC B01D 47/14

(57) ABSTRACT

A scrubber system for removing odorous and/or harmful gases from polluted gases/air comprising a scrubber body, a blower to supply the polluted gas into the scrubber body under pressure enabling the supplied polluted gas to travel from lower portion of the scrubber body to upper portion of the scrubber body and one or more diffraction units provided with supply of wash solution accommodated inside of the scrubber body and disposed in pathway of the polluted gas within the scrubber body to diffract the polluted gases/air with the wash solution thereby to clean the polluted gases/air and discharge clean gases/air through a scrubber body outlet at its top.

### BACKGROUND OF THE INVENTION

### Field of the Invention

The present invention relates to diffraction-type scrubber system for removing pollutants like odorous and/or harmful gases from polluted industrial exhaust gas streams. More particularly, the present invention relates to a diffraction-type scrubber system including diffraction plate facilitating generation of swirl bubbles in involving wash solution contained in the diffraction plates upon exposure to the polluted industrial exhaust gas streams for effective removal of the pollutants. According to a further aspect the present invention also provides for user friendly and maintenance friendly modular diffraction plates for easy assembling and use for pollutant removal in the scrubber system.

### Background of the Related Art

Presently different pollution control devices such as dust collectors, absorption towers or scrubber systems are widely used in different industrial fields for removing pollutants like dusts, particulates and harmful gases from the polluted industrial exhaust streams. Among these different pollution control devices, the scrubber systems have the advantage of simultaneously removing the dusts, particulates, harmful gases and hot gases and thus the scrubber systems are widely used in the industrial fields for removing the pollutants from the industrial exhaust streams.

The scrubber systems are basically a diverse group of the pollution control device and can be classified into dry type, wet type and burn-wet type. The wet type scrubber systems among all types of the scrubber systems are particularly preferred for removing the pollutants from industrial exhaust gas streams since the wet type scrubber systems have added advantages of low maintenance cost along with simultaneous dusts, mists and various air pollutants removal capability and adaptability for executing distillation and humidification.

The wet type scrubber system generally employs absorption solution or wash solution such as water for effective removal of the pollutants from the polluted industrial exhaust gas streams wherein the polluted industrial gas stream is brought into contact with the wash solution so as to remove the pollutants. The wash solution of the wet type scrubber system removes the pollutants by use of chemical reaction, such as neutralization, on an interface between the pollutants and the wash solution.

The performance of the wet type scrubber system is determined by efficient interface between the harmful gas and the wash solution containing the absorption water. In order to allow the harmful gas and the wash solution containing the absorption water to sufficiently come into contact with each other, various packs or spray nozzle for supplying water of fine particles is generally used.

In Korean Patent No. 638517, there is disclosed a diffraction-type wet scrubber system with improved pollutant removal efficiency. The diffraction-type wet scrubber system of the Korean Patent No. 638517 basically involves diffraction plate which enables the wash solution and the odorous and/or harmful gas of the industrial exhaust gas stream to come into good contact with each other and improves the contact efficiency between the wash solution and the odorous and/or harmful gas by giving orientation to the wash solution containing the absorption water sprayed onto the diffraction plate to change traveling direction of the odorous and/or harmful gas.

Korean Patent No. 652969 discloses a diffraction-type ultrasonic scrubber system which additionally includes ultrasonic device to further improve the contact efficiency and the pollutant removal efficiency. The ultrasonic device is configured to apply ultrasound to each part of the diffraction-type ultrasonic scrubber system for increasing the contact efficiency and the pollutant removal efficiency. Korean Patent Nos. 948652 and 1680634 disclose a swirl/diffraction-type scrubber having at least two perforated rectangular plates.

Although involvement of the diffraction plate in the wet scrubber system for increasing the contact efficiency and the pollutant removal efficiency in the wet type scrubber systems have been explored in above patents, there has been continued need in the art to provide for better modes of interaction of the pollutants in gas/air with the wash salutation for a more controlled and confirmatory method of arresting the pollutants in air/gases in the wash solution to generate clean gas/air.

Moreover, the diffraction plates used in wet scrubber systems presently in use are found to be difficult to manufacture considering the sizes involved such as diameter of about 2000 mm about 4000 mm or above and in such scrubber system, the diffraction plate is required to be manufactured in a large measure to further match with the diameter of the scrubber system. It is thus experienced that it is difficult to manufacture a single circular or rectangular diffraction plate of such large dimension.

In order to solve the above problems, there has been a need for further advancements in diffraction plate structures so as to make it serve effective purposes of removal of pollutants by way of better interaction with the wash solution on one hand and on the other hand adapting the same to make it user friendly to assemble and use in relation to the huge scrubber systems usually required for cleaning of pollutants from air/gases.

### SUMMARY OF THE INVENTION

Therefore, the present invention has been made in view of the above problems, and an object of the present invention is to provide a diffraction plate having a new structure to maximize a contact between a wash solution and an odorous and/or harmful gas.

Another object of the present invention is to provide a diffraction plate capable of maximizing maximize a contact between a wash solution and an odorous and/or harmful gas by generating swirl bubbles.

The other object of the present invention is to provide a diffraction-type scrubber system capable of maximizing a contact between a wash solution and an odorous and/or harmful gas by generating swirl bubbles to improve removal efficiency.

A further object of the present invention is to provide a diffraction-type scrubber system having a diffraction structure made by installing plural modular diffraction plates of a desired size.

A further object of the present invention is to provide a diffraction-type scrubber system which can be easily manufactured, installed and maintained, since a diffraction plate is standardized.

A further object of the present invention is to provide a diffraction-type scrubber system, of which a diffraction plate can be easily manufactured, installed and maintained, to decrease a manufacture cost.

The above or other objects of the present invention can be achieved by the present invention described below.

According to a basic aspect of the present invention there is provided a diffraction structure for use in a scrubber system for facilitating interaction of pollutant gases/air with wash solution in scrubber systems including at least one diffraction plate having an assembly of spaced apart a perforated upper plate and a perforated lower plate, each said perforated upper plate and said perforated lower plate having a plurality of passing holes on their planer surface and assembled one over the other enabling said passing holes in the perforated upper plate and the perforated lower plate are disposed in a zigzag pattern whereby the polluted gases/air while moving upwards and upon contact with the wash solution in said diffraction plate while passing through said passing holes in said perforated upper and lower plates of said diffraction plate generate swirl bubbles within the wash solution under pressure of said polluted air/gases moving upwards for maximizing contact with said polluted gases/air and efficient cleaning of the polluted gases/air for release of clean gases/air. The perforated lower plate is assembled along four sides thereof to attach it to the lower portion of the horizontal support, and the upper perforated plate is assembled by a securing member in such a way that it is only attached to center portion of the horizontal support and the perforated lower plate.

According to another preferred aspect there is provided a diffraction structure as above comprising of modularly configurable diffraction plates , each said modular diffraction plates comprising an assembly of spaced apart a perforated upper plate and a perforated lower plate, each said perforated upper plate and said perforated lower plate having a plurality of passing holes on their planer surface and assembled one over the other enabling said passing holes in the perforated upper plate and the perforated lower plate are disposed in a zigzag pattern whereby the polluted gases/air while moving upwards and upon contact with the wash solution in said diffraction plate while passing through said passing holes in said perforated upper and lower plates of said diffraction plate generate swirl bubbles within the wash solution under pressure of said polluted air/gases moving upwards for maximizing contact with said polluted gases/air and efficient cleaning of the polluted gases/air for release of clean gases/air through the scrubber body outlet. The perforated lower plate is assembled along four sides thereof by bolts to attach it to the lower portion of the horizontal support, and the upper perforated plate is assembled by bolts at the upper portion of the horizontal support in a such way that it is only attached at center portion to the horizontal support and the perforated lower plate. The perforated upper plate should be made of flexible synthetic resin, such that it distances apart at both sides by the pressure of the gases/air.

According to one aspect of the present invention, there is provided a scrubber system for removing odorous and/or harmful gases from polluted gases/air comprising a scrubber body, a blower to supply the polluted gases/air to be cleaned under pressure into the scrubber body near its lower portion enabling the supplied polluted gases/air to travel from said lower portion of said scrubber body to upper portion of said scrubber body, and at least one diffraction unit provided with supply of wash solution disposed in the upper portion inside of the scrubber body and in pathway of the polluted gases/air to diffract the polluted gases/air with the wash solution thereby to clean the polluted gases/air and discharge clean gases/air through a scrubber body outlet at its top. The diffraction unit may includes one or more modular diffraction plates each having an assembly of spaced apart a perforated upper plate and a perforated lower plate wherein each said perforated upper plate and said perforated lower plate includes plurality of passing holes on their planer surface. The perforated upper plate and the perforated lower plate are assembled one over the other enabling the passing holes in the perforated upper plate and the perforated lower plate are disposed in a zing zag pattern whereby the polluted gases/air while moving upwards and upon contact with said wash solution in said diffraction unit while passing through said passing holes in the perforated upper and lower plates of the diffraction unit generate swirl bubbles within the wash solution under pressure of said polluted air/gases moving upwards for maximizing contact with said polluted gases/air and efficient cleaning of the polluted gases/air for release of clean gases/air through the scrubber body outlet. The present scrubber system also comprises pump to circulate the wash solution stored in the lower portion of the scrubber body to the diffraction units and demister installed in the upper portion of the scrubber body to remove mist from the cleaned gases/air prior to its exit through the scrubber body outlet.

In a preferred embodiment of the present scrubber system, the diffraction unit is supported and assembled with respect to the scrubber body by a horizontal support in planer configuration providing planer perforated surface of the lower and the upper plates of the diffraction plate of the diffraction unit orthogonal to the pathway of the polluted gases/air within the scrubber body. The perforated upper plate and the perforated lower plate are assembled by fastening bolts into threaded holes provided along periphery of said plates with the horizontal support being interposed in between so that the spaced apart upper and lower plates maintained at an interval between them equal to width of the horizontal support.

In the present scrubber system, the passing holes in the perforated upper plate which are disposed in zigzag pattern with respect to the passing holes in the perforated lower plate in the diffraction plate include each of the passing holes in the perforated upper plate has at its underneath an opaque portion of the perforated lower plate and alternatively each of the passing holes in the perforated lower plate has at its above an opaque portion of the perforated upper plate. This zigzag patterned disposition of the passing holes allows discharging of the wash solution supplied on top of said diffraction plate through its bottom when the scrubber system does not operate and thereby directing the wash solution contained in or top of the diffraction plates of any diffraction unit to the top of the diffraction plates of its lower diffraction unit and finally to the lower portion of the scrubber body when the scrubber system does not operate. Further, the zigzag patterned disposition of the passing holes also prevents discharging of the wash solution supplied to the diffraction plate through its bottom by involving the pressure of the polluted gases/air supplied from its bottom and facilitates the generation of swirl bubbles in the wash solution contained in the top of the diffraction plate and in the interval between the perforated upper plate and the perforated lower plate thereby effectively cleaning the polluted gases/air, whereby the wash solution overflowing from the top of the diffraction plates of any diffraction unit flows to the top of the diffraction plates of its lower diffraction unit and finally to the lower portion of the scrubber body during operation of the scrubber system.

With the above configuration, the scrubber according to the present invention can maximize the contact between the wash solution and the odorous and/or harmful gas to improve the removal efficiency. Since the scrubber system includes the diffraction unit having at least one modular diffraction plate of a desired size, the scrubber system can be easily manufactured. In addition, the scrubber can be easily manufactured, installed and maintained, thereby decreasing its manufacture cost.

### BRIEF DESCRIPTION OF THE DRAWINGS

FIG. 1a is a schematic illustration of a preferred embodiment of the scrubber system with modular diffraction plate based diffraction structures according to the present invention.

FIG. 1b is a schematic illustration of an embodiment of the present scrubber system with two modular diffraction plate based diffraction structures.

FIG. 2a is a cross-sectional view taken from the line A in FIG. 1b.

FIG. 2b is a cross-sectional view taken from the line B in FIG. 1b.

FIG. 3a is a plan view of an lower plate associated with the diffraction plate based diffraction structure of the present scrubber system.

FIG. 3b is a plan view of a upper plate associated with the diffraction plate based diffraction structure of the present scrubber system.

FIG. 4a is a perspective view schematically illustrating a lower plate assembled along four sides thereof to attach it to the lower portion of the horizontal support, and an upper perforated plate assembled by a securing member in such a way that it is only attached to center portion of the horizontal support and the perforated lower plate, in which both ends of the upper plate are raised by the pressure of gas/air.

FIG. 4b is a cross-sectional view of FIG. 4a.

FIG. 4c is an exploded perspective view of FIG. 4b.

FIG. 5 is a plan view schematically illustrating positions of holes formed in the upper and lower plates in which the upper plate and the lower plate are installed to the support to form the diffraction plate.

### DETAILED DESCRIPTION OF THE PREFERRED EMBODIMENT

As stated hereinabove, the invention described herein relates to a diffraction type wet scrubber system capable of removing pollutant like odorous and/or harmful gases/air from polluted industrial exhaust gas/air streams. The present diffraction-type wet scrubber system comprises modular diffraction plate based single or multi-layered diffraction structure which enables the wash solution of the scrubber system and the odorous and/or harmful gas of the industrial exhaust gas stream to come into good contact with each other and thereby facilitates generation of swirl bubbles in the wash solution contained in the diffraction structures to improve removal of the pollutant from the polluted industrial exhaust streams. Preferred embodiments of the present system are now described hereunder in detail with reference to the accompanying drawings.

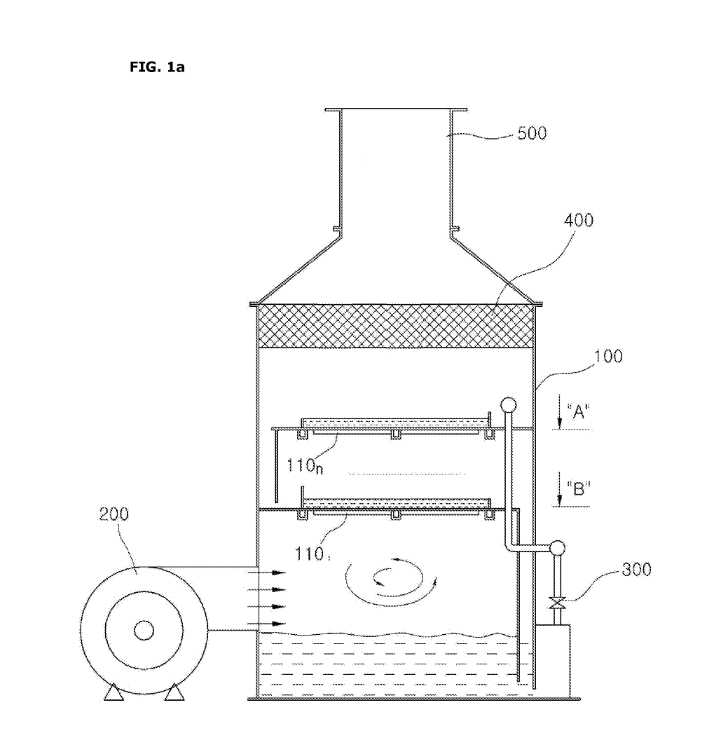

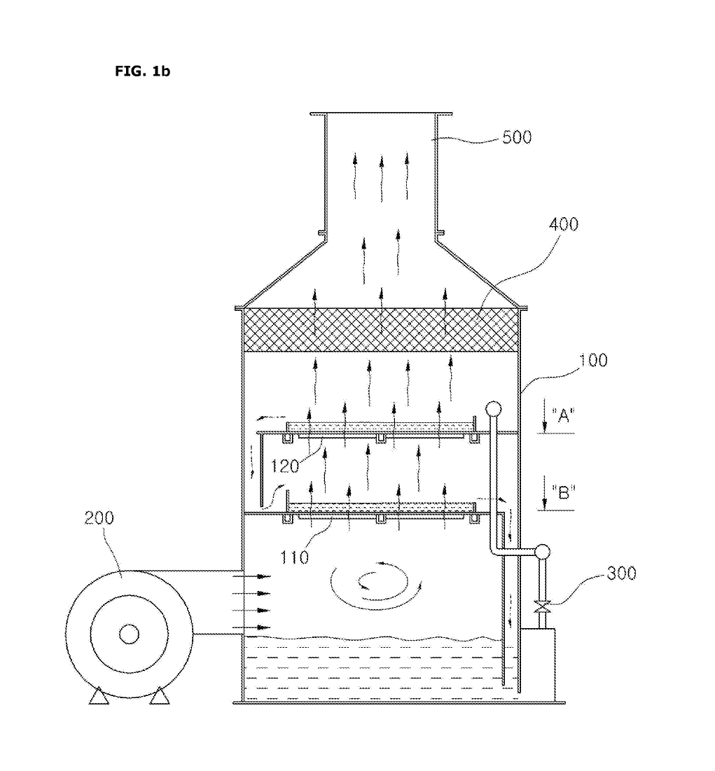

Reference is first invited from the accompanying drawing FIG. 1a which shows a vertical cross-sectional view of a preferred embodiment of the present diffraction- type wet scrubber system.

As shown in the referred drawing FIG. 1a, the present diffraction-type wet scrubber system basically comprises a scrubber body (100), a blower (200) having operative connection with the scrubber body to supply the polluted industrial exhaust gas into the scrubber body (100) under pressure and enabling the supplied polluted gas to travel from lower portion of the scrubber body to upper portion of the scrubber body, one or more diffraction units (110₁ . . . 110ₙ) arranged in layered configuration on the pathway of the polluted gas within the scrubber body (100) to diffract the polluted gas with the wash solution contained therein and a pump (300) to facilitate circulation of the wash solution stored in lower portion of the scrubber body (100) through all the diffraction units (110₁ . . . 110ₙ). A demister (400) is also installed in the upper portion of the scrubber body (100) above the diffraction structures to remove mist from cleaned gas coming from the diffraction units. An outlet port (500) is provided on top of the scrubber body (100) through which the cleaned gas is discharged.

In an alternate embodiment, the pump (300) may be external to the scrubber body (100) having operative connection with the lower portion within the scrubber body (100) and top diffraction unit to circulate the wash solution among the diffraction units (110₁ . . . 110ₙ).

Each of the diffraction units of the present diffraction- type wet scrubber system comprises one or more modularly arranged diffraction plates. The modular diffraction plates are assembled over a horizontal support attached with the scrubber body ensuring planer surfaces of the diffraction plates are orthogonal to the pathway of the polluted gas within the scrubber body.

While the scrubber system is in operating condition, the diffraction plates of the diffraction units prevent discharging of the circulated or supplied wash solution by involving the pressure of the polluted gas supplied from bottom and facilitates generation of swirls in the wash solution contained in the diffraction plates of the diffraction units to wash the polluted gas moving from the lower portion to the upper portion of the scrubber body. During the operation of the scrubber system, as the pump continuously circulates the wash solution contained in lower portion of the scrubber body to top of the diffraction units, the wash solution overflowing from the top of the diffraction plates of a diffraction unit flows to the top of the diffraction plates of lower diffraction unit in the multi-layered diffraction structure and finally to the lower portion of the scrubber body, and then the wash solution is again fed to the upper portion by the pump for the purpose of continuous circulation.

The operation of the present diffraction type wet scrubber system is further explained with reference to the accompanying drawing FIG. 1b, which shows an embodiment of the present diffraction type wet scrubber system having two diffraction units (110, 120) arranged in the layered configuration. During pollutant removing operation, the scrubber body (100) is supplied with the polluted gas by the blower (200) and the wash solution contained in the lower portion of the scrubber body (100) is circulated to top of the diffraction units (110 and 120) by the pump (300). As shown in the accompanying drawing FIG. 1b, the first diffraction unit (110) and the second diffraction unit (120) are installed inside the scrubber body (100) in layered configuration wherein both the diffraction units (110, 120) are provided with the diffraction plates which enables discharging of the supplied wash solution to the lower portion in the state in which the scrubber system does not operate. While the scrubber system is in operating state, the supplied wash solution does not drop onto the lower portion due to pressure of the polluted air supplied from the lower portion of the scrubber body (100), but swirls is generated in the wash solution contained in the diffraction plates of the diffraction units (110,120) to wash the polluted gas moving from the lower portion to the upper portion. The wash solution overflowing from the upper diffraction unit (120) flows to the lower diffraction unit (110) and finally to the lower portion of the scrubber body (100), and then is fed to the top of the upper diffraction unit (120) by the pump (300) for the purpose of continuous circulation. The flow of the gas in the scrubber body (300) is shown by continuous arrow whereas flow of the wash solution in the scrubber body is shown by broken arrow. The gas is cleaned by the swirl of the wash solution while passing through the diffraction units (110, 120), and then flows through the demister (400), so that the mist can be removed from the gas. After that, the cleaned gas is discharged outwardly from the outlet port (500). The scrubber is characterized by the diffraction units (110, 120) to diffract the polluted air by the wash solution thereby to clean the polluted air.

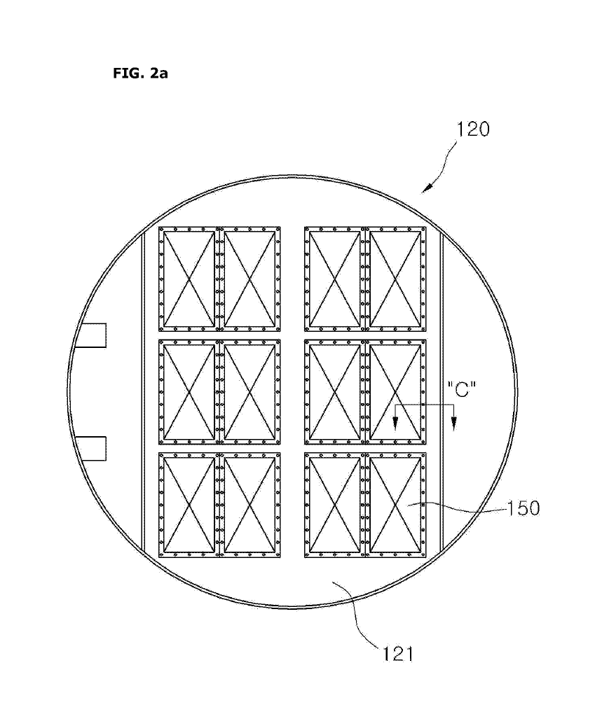

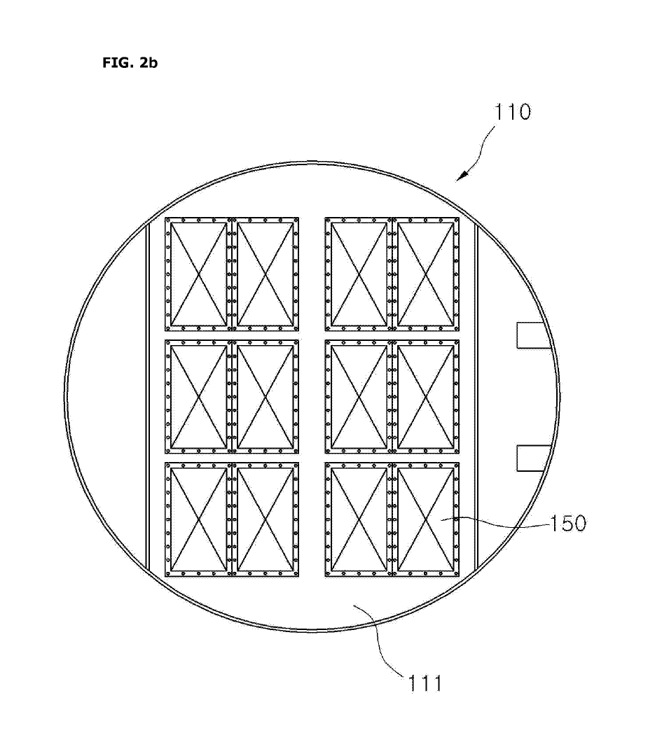

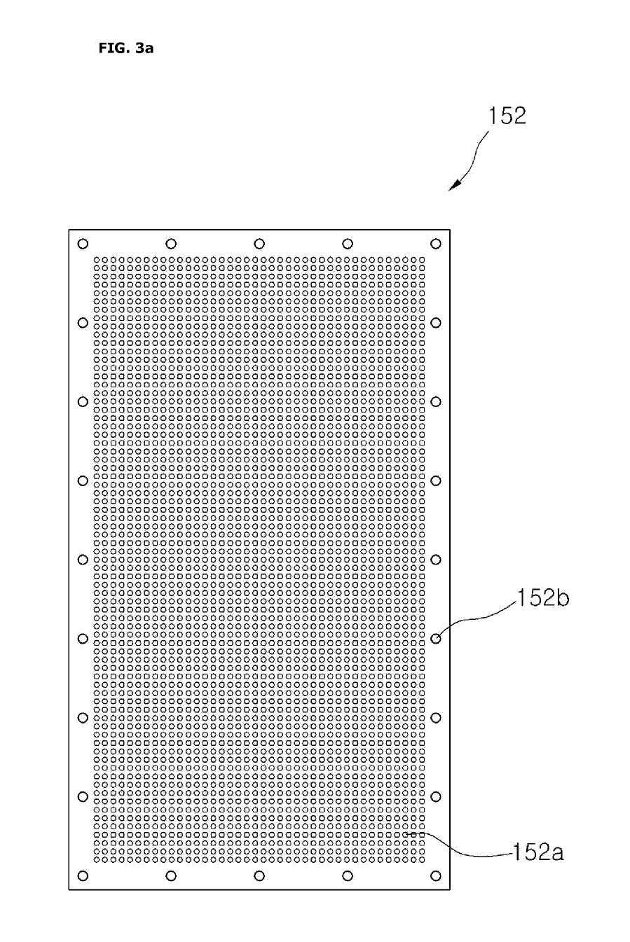

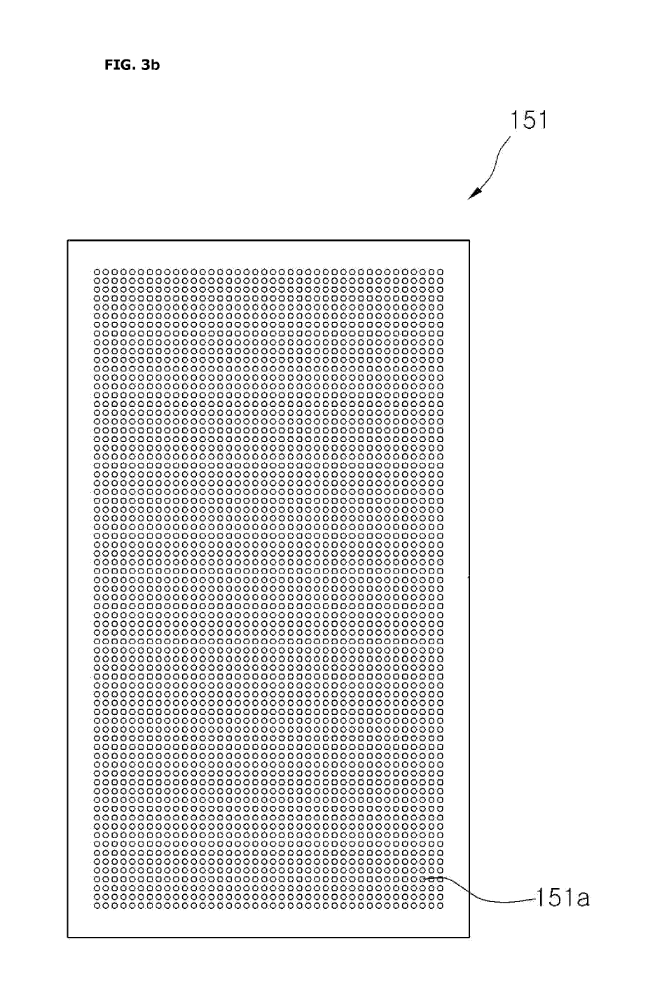

Reference is now invited from the accompanying FIGS. 2a and 2b which show embodiments of the diffraction unit involved in the present scrubber system. The accompanying FIG. 2a is a cross-sectional view taken from the line A in FIG. 1b whereas the accompanying FIG. 2b is a cross-sectional view taken from the line B in FIG. 1b. The diffraction unit may comprises one or more of said diffraction plates (150) modularly arranged and assembled to the horizontal supports (111, 121) which are fixed to the scrubber body (100) providing planer surface of said perforated diffraction plates (150) orthogonal to the pathway of the polluted gas within the scrubber body (100). The diffraction unit embodiment as shown in the FIGS. 2a and 2b, are provided with 12 modularly arranged diffraction plates (150). Each of the diffraction plates (150) include an assembly of spaced apart a perforated upper plate (151) and a perforated lower plate (152), wherein the perforated lower plate (152) is assembled along four sides thereof to attach it to the lower portion of the horizontal supports (111, 121), and the upper perforated plate (151) is assembled by a securing member in such a way that it is only attached to center portion of the horizontal supports (111, 121) and the perforated lower plate. The accompanying FIG. 3a shows a plane view of the perforated lower plate (152) and FIG. 3b shows plane view of the perforated upper plate (151). The perforated upper plate (151) is disposed over the perforated lower plate (152) maintaining an interval D of 5 to 10 mm between them in horizontal and vertical directions wherein both the perforated upper plate (151) and the perforated lower plate (152) are respectively provided with plurality of passing holes (151a) and (152a) on their planner surfaces. The passing holes (151a) and (152a) are selectively provided on the perforated upper plate (151) and the perforated lower plate (152) to ensure that the passing holes (151a) and (152a) are not being disposed along a straight line but to be disposed in a zigzag pattern when the perforated upper plate (151) is disposed over the perforated lower plate (152). In other word, the passing holes (151a) are disposed horizontally offset position with respect to the passing holes (152a) to provide the zigzag patterned disposition of the passing holes (151a, 152a) and each of the passing holes (151a) in the perforated upper plate (151) has at its underneath an opaque portion of the perforated lower plate (152), alternatively each of the passing holes (152a) in the perforated lower plate (152) has at its above an opaque portion of the perforated upper plate (151). This positional configuration of the passing holes (151a, 152a) ensures selective discharging and prevention of the wash solution from the diffraction plates as stated hereinbefore in the paragraph [38]. In the present scrubber system, due to the above zigzag patterned disposition of the passing holes (151a, 152a), the polluted gases/air while moving upwards inside the scrubber body (300) and upon contact with the wash solution contained in the diffraction plates of the diffraction unit while passing through the passing holes generate swirl bubbles within the contained wash solution under pressure of the upwardly moving polluted air/gases. The generated swirl bubbles maximize the contact between the passing polluted gases/air and the contained wash solution for efficient cleaning of the polluted gases/air and thereby release of the clean gases/air through the scrubber body outlet.

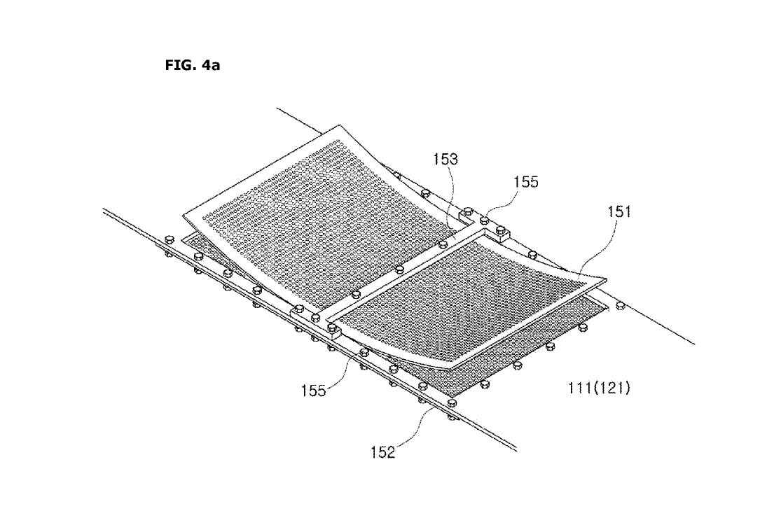

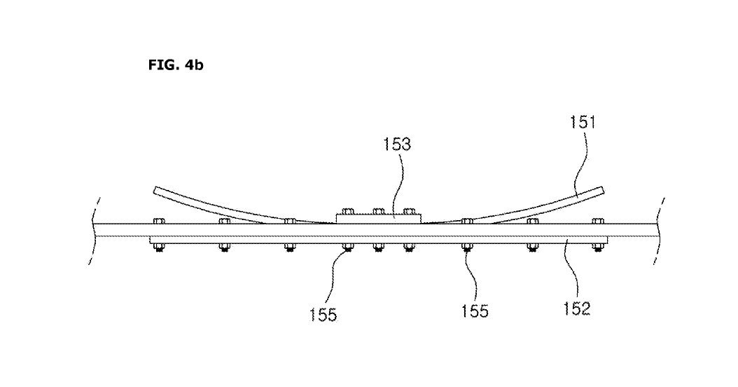

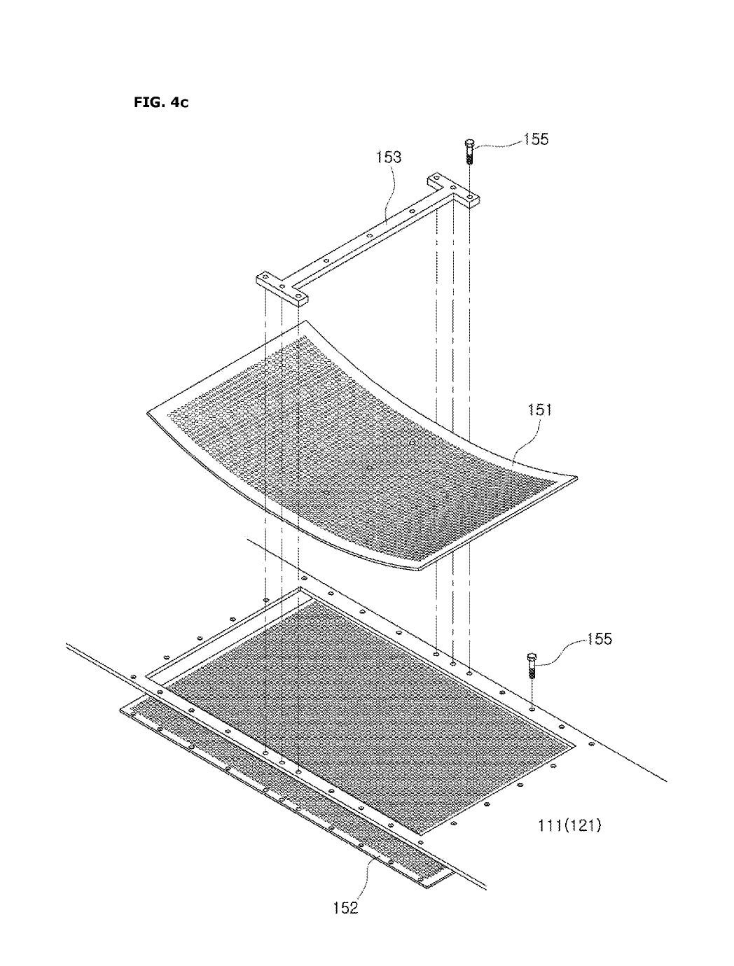

Even though each end and the main part of the securing member (153) of FIG. 4a and FIG. 4c have 3 bolt holes, it is not limited to this number. It is sufficient to have the perforated upper plate (151) attached only at the center portion in such a way that each ends can distance apart due to the pressure of gases/air.

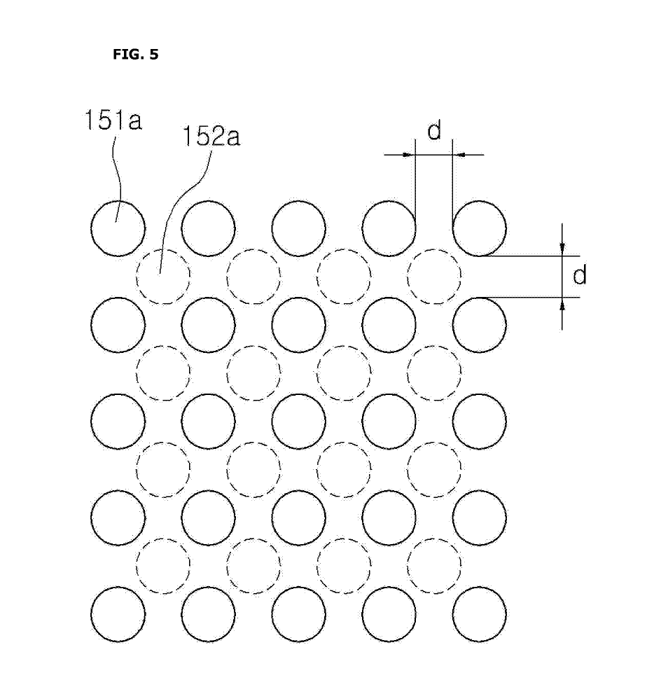

The zigzag patterned disposition of the passing holes (151a, 152a) when the perforated upper plate (151) is disposed over the perforated lower plate (152) is illustrated in the accompanying FIG. 4a. The accompanying FIG. 5 schematically illustrates the positions of the passing holes (151a, 152a) formed in the perforated upper and lower plates (151 and 152) in the state in which the perforated upper plate (151) and the perforated lower plate (152) are installed to the support (111 or 121) to form the diffraction plate (150); in words, when the perforated upper plate (151) is flat, not curved.

The perforated upper plate (151) and the perforated lower plate (152) are installed on the horizontal support (111 or 121) to constitute the perforated diffraction plate orthogonal to the pathway of the polluted gas in the scrubber body (100).

The perforated upper plate (151) and the perforated lower plate (152) are preferably made of a synthetic resin having a thickness of 3 to 10 mm. Synthetic resin like Polyethylene (PE), polyvinyl chloride (PVC), or polyester (PET) can be used to fabricate the plates (151, 152). The perforated upper plate (151) and the perforated lower plate (152) are assembled at a desired interval by the fastening bolts (155) along four sides thereof, in such a way that the perforated lower plate (152) is attached to the lower portion of the horizontal supports (111, 121), and the upper perforated plate (151) is assembled by a securing member (153) in such a way that it is only attached to center portion of the horizontal supports (111, 121) and the perforated lower plate (152). The perforated upper plate (151) should be made of flexible synthetic resin to allow both ends to distance apart upwardly from the pressure of gases/air. The perforated upper plate (151) and the perforated lower plate (152) are a rectangular standardized diffraction plate, and are made to have a size of 400 to 600 in width and 600 to 1000 mm in length depending on the size of the scrubber body (100).

The horizontal supports (111, 121) are generally made of fiber reinforced plastic (FRP) having a thickness of 5 to 10 mm, and are provided with a plurality of openings having a size smaller than that of the diffraction plate (150) at installed positions of the diffraction plates. The interval (D) between the perforated upper plate (151) and the perforated lower plate (152) is substantially identical to the thickness of the horizontal supports (111 and 121).

The perforated upper plate (151) and the perforated lower plate (152) are provided with the plurality of passing holes (151a and 152a) having a diameter of 5 to 10 mm, and disposed at a regular interval (d) of 5 to 10 mm. Due to the zigzag patterned disposition of the passing holes (151a, 152a), the wash solution does not easily pass through the diffraction plates of the diffraction units, and is swirled by the pressure of the gas flowing from the lower portion to the upper portion. The swirl is generated in the interval D between the upper plate 151 and the lower plate 152, and also is generated in the top of diffraction plate 150, thereby effectively washing the polluted gas.

FIG. 4a is a perspective view schematically illustrating a perforated lower plate (152) assembled along four sides thereof to attach it to the lower portion of the horizontal supports (111, 121), and an upper perforated plate (151) assembled by a securing member (153) in such a way that it is only attached to center portion of the horizontal supports (111, 121) and the perforated lower plate (152), in which the figure illustrates both ends of the upper plate (151) that are raised by the pressure of gas/air. When the scrubber is not operating, four corners of the perforated upper plate (151) and the horizontal supports (111, 121) are fully in contact with each other. In other words, when the pressure of gases/air is absent due to the scrubber not operating, the perforated upper plate (151) is in a horizontal state like the perforated lower plate (152) is. When the scrubber is operating, the perforated upper plate (151) is distance apart at both ends due to the pressure of gases/air.

Once the scrubber starts operating, both ends of the upper perforated plate (151) are distanced apart by the pressure of gases/air and the wash solution generates swirl bubbles in between. FIG. 4b is a cross-sectional view of FIG. 4a which illustrates the ends of the perforated upper plate (151) in distanced apart state. The amount the ends of the perforated upper plate (151) are distanced apart is proportional to the pressure of gases/air, i.e. gases/air volume, within the scrubber. As the gases/air volume increases, the amount the ends of the perforated upper plate (151) distance apart increases, and as the gases/air volume decreases, the amount the ends of the perforated upper plate (151) distance apart decreases.

FIG. 4c is an exploded perspective view of FIG. 4b. The method of assembling the perforated lower plate (152) along four sides thereof to attach it to the lower portion of the horizontal supports (111, 121), and assembling the perforated upper plate (151) in such a way that the center portion is only attached to the horizontal supports (111, 121) and the perforated lower plate (152) at the lower portion of the horizontal supports (111, 121) can be performed easily by a person of ordinary skill in the art.

The diffraction units (110, 120) may comprise plurality of modular diffraction plates (150) installed to the horizontal support (111, 121) which is fixed to the scrubber body (100). Generally, 2 to 24 diffraction plates can be installed depending upon the size of the scrubber body. The perforated upper plate (151) and the perforated lower plate (152) are the rectangular standardized diffraction plates which are made to have a size of 400 to 600 in width and 600 to 1000 mm in length. The plurality of modular diffraction plates (150) is installed to the horizontal support (111, 121) thereby easily manufacturing and installing the diffraction plate (150).

While the present invention has been described with reference to the particular illustrative embodiment, it is not to be restricted by the embodiments but only by the appended claims. It is to be appreciated that those skilled in the art can change or modify the embodiments without departing from the scope and spirit of the present invention.

What is claimed is:

1. A diffraction structure for use in a scrubber system for facilitating interaction of pollutant gases/air with wash solution in the scrubber systems including:
at least one diffraction plate having an assembly of spaced apart a perforated upper plate and a perforated lower plate, wherein the perforated lower plate is assembled along four sides thereof to attach it to the lower portion of a horizontal support, and the upper perforated plate is assembled in such a way that the center portion is only attached to the horizontal support and the perforated lower plate at the lower portion of the horizontal support; and each said perforated upper plate and said perforated lower plate having a plurality of passing holes on their planer surface and assembled one over the other enabling said passing holes in the perforated upper plate and the perforated lower plate are disposed in a zigzag pattern whereby the polluted gases/air while moving upwards and upon contact with the wash solution contained in said diffraction plate while passing through said passing holes in said perforated upper and lower plates of said diffraction plate generate swirl bubbles within the wash solution under pressure of said polluted air/gases moving upwards for maximizing contact with said polluted gases/air and efficient cleaning of the polluted gases/air for release of clean gases/air.

2. The diffraction structure as claimed in claim 1 comprising of modularly configurable modular diffraction plates, each said modular diffraction plates comprising an assembly of spaced apart a perforated upper plate and a perforated lower plate, each said perforated upper plate and said perforated lower plate having a plurality of passing holes on their planer surface and assembled one over the other enabling said passing holes in the perforated upper plate and the perforated lower plate are disposed in a zigzag pattern whereby the polluted gases/air while moving upwards and upon contact with the wash solution contained in said diffraction plate while passing through said passing holes in said perforated upper and lower plates of said diffraction plate generate swirl bubbles within the wash solution under pressure of said polluted air/gases moving upwards for maximizing contact with said polluted gases/air and efficient cleaning of the polluted gases/air for release of clean gases/air.

3. The diffraction structure as claimed in claim 1, wherein the perforated upper plate, the horizontal support, and the perforated lower plate are assembled together by a securing member with bolts.

4. A scrubber system for removing odorous and/or harmful gases from polluted gases/air comprising:
a scrubber body;
a blower to supply the polluted gases/air to be cleaned under pressure into the scrubber body near its lower portion enabling the supplied polluted gases/air to travel from said lower portion of said scrubber body to an upper portion of said scrubber body; and
at least one diffraction unit provided with supply of wash solution disposed in the upper portion inside of the scrubber body and in pathway of the polluted gases/air to diffract the polluted gases/air with the wash solution thereby to clean the polluted gases/air and discharge clean gases/air through a scrubber body outlet at its top; said at least one diffraction unit including at least one diffraction plate having an assembly of spaced apart a perforated upper plate and a perforated lower plate, each said perforated upper plate and said perforated lower plate having a plurality of passing holes on their planer surface and assembled one over the other enabling said passing holes in the perforated upper plate and the perforated lower plate are disposed in a zigzag pattern whereby the polluted gases/air while moving upwards and upon contact with said wash solution in said diffraction unit while passing through said passing holes in said perforated upper and lower plates of said diffraction plate generate swirl bubbles within the wash solution under pressure of said polluted air/gases moving upwards for maximizing contact with said polluted gases/air and efficient cleaning of the polluted gases/air for release of clean gases/air through the scrubber body outlet.

5. The scrubber system as claimed in claim 4, including
said scrubber body with the wash solution stored at the lower portion inside of the scrubber body;
said blower to supply the polluted gases/air to be cleaned into the scrubber body under pressure into the scrubber body near its lower enabling the supplied polluted gases/air to travel from the lower portion of said scrubber body to the upper portion of said scrubber body;
plurality of said diffraction unit arranged in layered configuration forming multi-layered diffraction structure disposed in the upper portion inside the scrubber body, each of said diffraction units includes said diffraction plates modularly arranged to diffract the supplied polluted gases/air with the wash solution thereby to clean the polluted gas/air and discharge clean gas/air through the scrubber body outlet;
pump to circulate the wash solution stored in the lower portion of the scrubber body to each said diffraction units;
each of said modular diffraction plates comprises an assembly of spaced apart a perforated upper plate and a perforated lower plate, each said perforated upper plate and said perforated lower plate having a plurality of passing holes on their planer surface and assembled one over the other enabling said passing holes in the perforated upper plate and the perforated lower plate are disposed in a zigzag pattern whereby the polluted gases/air while moving upwards and upon contact with said wash solution in said diffraction unit while passing through said passing holes in said perforated upper and lower plates of said diffraction plate generate swirl bubbles within the wash solution under pressure of said polluted air/gases moving upwards for maximizing contact with said polluted gases/air and efficient cleaning of the polluted gases/air for release of clean gases/air through the scrubber body outlet.

6. The scrubber system as claimed in claim 4 comprises demister installed in the upper portion of the scrubber body to remove mist from the cleaned gases/air prior to its exit through the scrubber body outlet.

7. The scrubber system as claimed in claim 4, wherein the diffraction unit is supported and assembled with respect to the scrubber body by a horizontal support in planer configuration providing planer perforated surface of the lower and the upper plates of the diffraction plate of the diffraction unit orthogonal to the pathway of the polluted gases/air within the scrubber body.

8. The scrubber system as claimed claim 7, wherein the horizontal support includes plurality of openings having a size smaller than that of the diffraction plates at installed positions of the diffraction plates on said horizontal support.

9. The scrubber system as claimed in claim 4, wherein the passing holes in the perforated upper plate which are disposed in zigzag pattern with respect to the passing holes in the perforated lower plate in the diffraction plate includes each of the passing holes in the perforated upper plate has at its underneath an opaque portion of the perforated lower plate and alternatively each of the passing holes in the perforated lower plate has at its above an opaque portion of the perforated upper plate.

10. The scrubber system as claimed in claim 4, wherein the passing holes in the perforated upper plate which are disposed in zigzag pattern with respect to the passing holes in the perforated lower plate in the diffraction plate allows discharging of the wash solution supplied on top of said diffraction plate through its bottom when the scrubber system does not operate and thereby directing the wash solution contained in or top of the diffraction plates of any diffraction unit to the top of the diffraction plates of its lower diffraction unit and finally to the lower portion of the scrubber body when the scrubber system does not operate.

11. The scrubber system as claimed in claim 4, wherein the passing holes in the perforated upper plate which are disposed in zigzag pattern with respect to the passing holes in the perforated lower plate in the diffraction plate prevents discharging of the supplied wash solution on top said diffraction plate through its bottom by involving the pressure of the polluted gases/air supplied from its bottom and facilitates the generation of swirl bubbles in the wash solution contained in the top of the diffraction plate and in the interval between the perforated upper plate and the perforated lower plate thereby effectively cleaning the polluted gases/air, whereby the wash solution overflowing from the top of the diffraction plates of any diffraction unit flows to the top of the diffraction plates of its lower diffraction unit and finally to the lower portion of the scrubber body during operation of the scrubber system.

12. The scrubber system as claimed in claim 5, wherein the pump is configured to supply the wash solution stored in the lower portion of the scrubber body to top of uppermost diffraction structures to continuously circulates the wash solution though all the diffraction units accommodated in the scrubber body.

13. The scrubber system as claimed in claim 7, wherein the horizontal support is made of fiber reinforced plastic having a thickness of 5 to 10 mm.

14. The scrubber system as claimed in claim 4, wherein the perforated upper plate and the perforated lower plate are made of synthetic resin including polyethylene (PE), polyvinyl chloride (PVC), or polyester (PET) having a thickness of 3 to 10 mm.

15. The scrubber system as claimed in claim 14, wherein the perforated upper plate is flexible.

16. The scrubber system as claimed in claim 3, wherein the perforated upper plate and the perforated lower plate are rectangular standardized diffraction plate having width between 400 to 600 mm and length between 600 to 1000 mm depending on size of the scrubber body.
